(19) United States
(12) Patent Application Publication
(10) Pub. No.: US 2024/0308306 A1
(43) Pub. Date: Sep. 19, 2024

(54) SPLIT DOOR SIDE ASSIST STEP COMBINATION

(71) Applicant: FCA US LLC, Auburn Hills, MI (US)

(72) Inventors: James J. Metcalf, Plymouth, MI (US); Robert P. Langer, Warren, MI (US)

(21) Appl. No.: 18/182,465

(22) Filed: Mar. 13, 2023

(51) Int. Cl. B60J 5/04; B60R 3/02

(52) U.S. Cl. CPC B60J 5/0473; B60R 3/02

(57) ABSTRACT

A door for an automotive vehicle has a first portion and a second portion. The first portion pivots with respect to an A pillar and the second portion pivots with respect to the floor deck. The second portion extends toward the ground in an open position. At least one stair on the second portion assists with ingress and egress to the vehicle.

### FIELD

The present disclosure relates to automobiles and, more particularly, to vehicle doors with an assist step.

### BACKGROUND

This section provides background information related to the present disclosure which is not necessarily prior art.

Previous vehicle with a high step into the vehicle typically utilize a side step, fixed running board or electrically retractable running boards to assist the occupant with ingress and egress. The added steps or running boards added to the vehicle are susceptible to snags and damage and can also reduce ground clearance. This is clearly undesirable for a vehicle that is intended for off-road use. Thus, it is desirable to overcome the clumsy addition of side steps or running boards.

### SUMMARY

This section provides a general summary of the disclosure, and is not a comprehensive disclosure of its full scope or all of its features.

Accordingly, it is an object of the present disclosure to provide a step that assist ingress and egress to the vehicle without the addition of the side steps or running boards. The present disclosure provides the needed assist step for ingress and egress without the undesirable effects of mounting steps or running boards to the side or beneath the vehicle.

According to a first aspect of the disclosure, a door for an automotive vehicle comprises a first portion and a second portion. The first portion pivots about an A pillar. The second portion pivots with respect to the floor deck such that the second portion extends towards the ground. At least one stair is formed on the second portion to assist with ingress and egress to the vehicle. The second portion has a height of about ⅓ the height of the entire door. The second portion may include a plurality of stairs. Also, the ingress and egress steps are positioned within the passenger compartment of the vehicle when the door is in a closed position. The first portion can be removed from the vehicle and the first portion is secured to the second portion when the door is closed with respect to the vehicle body.

According to a second aspect of the disclosure, an automotive vehicle comprises a body including a pair of openings for receiving the door. A pair of doors are coupled with the body for enclosing the openings in a first position. Each door is a split door including a first portion and a second portion. The first portion pivots about an A pillar. The second portion pivots with respect to the floor deck such that the second portion extends towards the ground. At least one stair is formed on the second portion to assist with ingress and egress to the vehicle. The second portion has a height of about ⅓ the height of the entire door. The second portion may include a plurality of stairs. Also, the ingress and egress steps are positioned within the passenger compartment of the vehicle when the door is a closed position. The first portion can be removed from the vehicle and the first portion is secured to the second portion when the door is closed with respect to the vehicle body.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side elevational view of a vehicle.

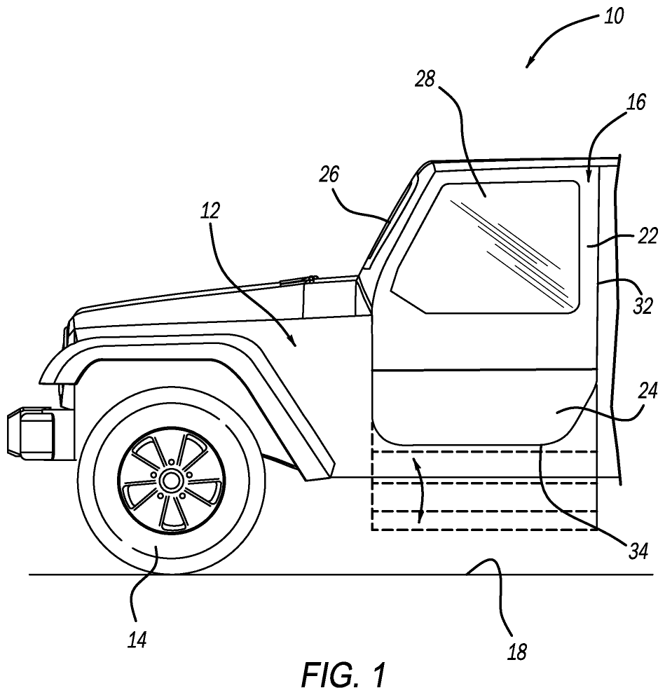

FIG. 2 is a rear plan view of the vehicle of FIG. 1.

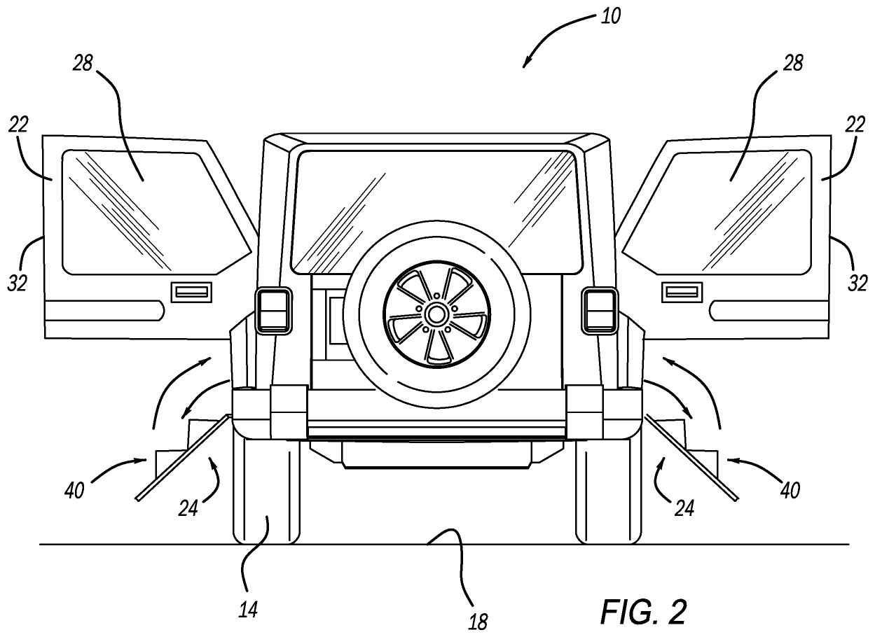

Corresponding reference numerals indicate corresponding parts throughout the several views of the drawings.

### DETAILED DESCRIPTION

Example embodiments will now be described more fully with reference to the accompanying drawings.

Turning to the figures, a vehicle is illustrated and designated with the reference numeral 10. The vehicle includes a body 12 to which wheels 14 are provided. The vehicle 10 includes a door 16 on each side of the vehicle. The vehicle has a clearance height away from the ground 18. This enables the vehicle to be used as an off-road vehicle since the clearance between the vehicle and the ground is great. Also, the user may obtain larger tires that elevates the body further from the ground.

The door 16 is a split door having a first portion 22 and a second portion 24. The first portion 22 is pivotable with respect to an A pillar 26. Thus, the first portion of the door opens as is conventional in a vehicle. The first portion 22, as well as the top 28, may be removed from the vehicle to provide a convertible type of SUV. The first portion 22 may include a window 28. Also, the door may include means such as hook and loop fasteners, magnets, and fasteners or the like to secure the first portion 22 with the second portion 24 when the door 16 covers the opening 32 in the body 12.

The second portion 24 has a height of about ⅓ of the total height of the door 16. Thus, the second door portion 24 pivots with respect to the floor board 34. Thus, the second door portion 24 extends toward the ground 18 as it is opened. The second door portion 24 includes a latch or the like that secures the door portion with an A or B, or both, pillars.

The second door portion 24 includes one or more steps or stairs 40. The steps or stairs 40 enable the user to climb onto the stairs 40 to enter or exit into the vehicle. The stairs 40 are generally integrally formed with the second door portion 24 or could be welded or the like to the door. The step or stairs 40 may span the entire width of the door Portion 24 or may have a limited width providing the stairs for ingress and egress to the vehicle.

Also, since the first portion 22 of the door 16 may be removed from the vehicle, it may be made of a lighter, more stowable material. The second door portion 24, a third of the overall door height, will remain in a closed position when the occupant is inside the vehicle. This provides a more enclosed vehicle compartment.

Thus, when the occupant is in the vehicle, with the door closing the passenger compartment, the stairs or steps are stowed within the vehicle. Thus, this eliminates the outside mounting steps or running board on the side or beneath the vehicle. Additionally, this provides maximum ground clearance for the off the road vehicle. Additionally, the vehicle has a sleek look when the running boards or steps have been eliminated.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A door for an automotive vehicle having a substantially vertical A pillar and a substantially horizontal floor deck, the door comprising:
a first portion and a second portion, the first portion pivoting with respect to the A pillar and the second portion pivoting with respect to the floor deck, the second portion extends toward ground, at least one stair on the second portion for assisting with ingress and egress to the vehicle.

2. The door of claim 1, wherein the second portion has a height of about ⅓ of a height of the door.

3. The door of claim 1, wherein the second portion has a plurality of stairs.

4. The door of claim 1, wherein the first portion can be removed from the vehicle.

5. The door of claim 1, wherein the first portion is secured to the second portion in a closed door position.

6. The door of claim 1, wherein the door provides ingress and egress steps positioned inside a passenger compartment of the vehicle in a closed position.

7. An automotive vehicle comprising:
a body including an A pillar, a floor deck and a pair of openings for receiving a door;
a pair of doors coupling with the body for enclosing the openings in a first position;
each door has a first portion and a second portion, the first portion pivoting with respect to the body A pillar and the second portion pivoting with respect to the body floor deck, the second portion extends toward ground in a second position, at least one stair on the second portion for assisting with ingress and egress to the vehicle.

8. The automotive vehicle of claim 7, wherein the second portion has a height of about ⅓ of a height of the door.

9. The automotive vehicle of claim 17, wherein the second portion has a plurality of stairs.

10. The automotive vehicle of claim 7, wherein the first portion can be removed from the vehicle.

11. The automotive vehicle of claim 7, wherein the first portion is secured to the second portion in the first closed door position.

12. The automotive vehicle of claim 7, wherein the door provides ingress and egress steps positioned inside a passenger compartment of the vehicle.
